(19) United States
(12) Patent Application Publication
(10) Pub. No.: US 2009/0006634 A1
(43) Pub. Date: Jan. 1, 2009

(54) Run-once static content generation using a descriptive file path

(75) Inventors: Ryan Parsell, Puyallup, WA (US); Amol Kelkar, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/823,577

(22) Filed: Jun. 28, 2007

(51) Int. Cl. G06F 15/16

(52) U.S. Cl. 709/228

(57) ABSTRACT

A variation of a static base asset used to build a web page is generated responsively to a client browser request using a descriptive file path that is included with the base asset's file name in the request. The descriptive file path employs a specific syntax to declare one or more variable parameters which are placed in the file name. Different values for the variable parameters will map to different variations of the base asset which can be used to implement various themes or other characteristics for the page. Server-side processes parse the variable parameter names from the request, and specify values for them. The variation of the base static asset that maps to the specified values is located and retrieved from a resource store. That variation is renamed to match the file name contained in the request and is included in a response back to the client browser.

### BACKGROUND

Internet-based services are increasingly becoming focal points for individuals to bring together all of the elements of their digital worlds, and for enterprises to effectively do business online. Examples of such services include Microsoft Windows Live™ and Office Live which work through sites on the World Wide Web. Windows Live provides personal internet services designed to bring users' relationships, information, and interests together into one place in a manner that provides security features across their personal computers (“PCs”), devices, and the Web. Office Live services enable businesses to create an online presence through utilization of a hosted service and also use the Internet for storing, organizing, and managing their company information.

Internet-based services typically rely on well designed and crafted web pages to provide rich user experiences that are tailored to the user's needs. Text, images, and controls must all be deployed so as to present a clear and crisp interface while maintaining accessibility, and in a manner where the look and feel of the web site is attractive and compelling. Accordingly, themes are often applied to web sites to present a common appearance across multiple pages, or to enable customization to suit individuals or communities of users, for example those that may share a common language or culture, or live in the same region, etc. Themes are commonly implemented through the use of variable visual design content such as color, shapes, fonts, and metaphor that work with control and navigation functionality to enable users to readily interact with the site while motivating them to explore further.

Some service providers utilize themes in a dynamic manner in which content may be rendered using one or more of several alternative themes that are available at a given time. Or, service providers may release new themes which are intended to replace or supplement the original themes. In both cases, web site developers are typically faced with a significant task of developing and managing all of the code that is necessary for each piece of content on a page that has a different variation for each theme. For example, a control element such as a button on a page may be expressed using one of numerous variations in color, shading, size, geometry, and combinations thereof depending on the particular theme being invoked, even though its underlying functionality does not change with the changing themes. In addition, the release of new versions of themes can consume substantial overhead to locate and furnish the requested content which can slow the end-to-end delivery from the server to the client and thus diminish the quality of the user's experience when interacting with the page.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A variation of a static base asset used to build a web page is generated responsively to a client browser request by an arrangement in which a descriptive file path is included with the base asset's file name in the request. The descriptive file path employs a specific syntax to declare one or more variable parameters which are placed in the file name. Different values for the variable parameters will map to different variations of the base asset which can be used to implement various themes or other characteristics for the page. Server-side processes parse the variable parameter names from the request, and specify values for them. The variation of the base static asset that maps to the specified values is located and retrieved from a resource store. The newly created variation is renamed to match the file name contained in the request and is included in a response back to the client browser.

Advantageously, the utilization of the descriptive file path enables run-once generation of static web content that matches the description. The descriptive file path works as a key to the newly generated variations of the static base asset. As all subsequent requests for the variation will use the same key, the variation can be efficiently cached in web caches located between the server and the client to sharpen the responsiveness of a web site to the client. In addition, the descriptive file path can simplify page development by designers since a base asset will not need to be redeployed in order to accommodate new or changing themes. Because themes are defined by the values specified for the variable parameters, the declaration of a base asset in the descriptive file path does not have to change. When the specified values change, a different variation of the base asset will be mapped for inclusion in the response as required to implement the new or changed theme.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative internet-based service environment in which a client computer and a web server communicate over a network that includes web caches;

FIG. 2 shows an illustrative set of image assets that are describable by variable parameters;

FIG. 3 shows an illustrative set of icons that have different variable parameter values for size;

FIG. 4 shows how values for variable parameters may be changed to implement themes having distinct appearances;

FIG. 5 shows details of an illustrative web server for generating static content based on a request containing a descriptive file path;

FIG. 6 shows a flowchart for an illustrative method performed by the web server shown in FIG. 5;

FIG. 7 shows an illustrative screenshot of a web page rendered by a client browser in which resources are received and displayed in accordance with specified values; and

FIG. 8 shows an illustrative screenshot of a second web page rendered by a client browser in which resources are received and displayed in accordance with specified values.

Like reference numerals indicate like elements in the drawings.

### DETAILED DESCRIPTION

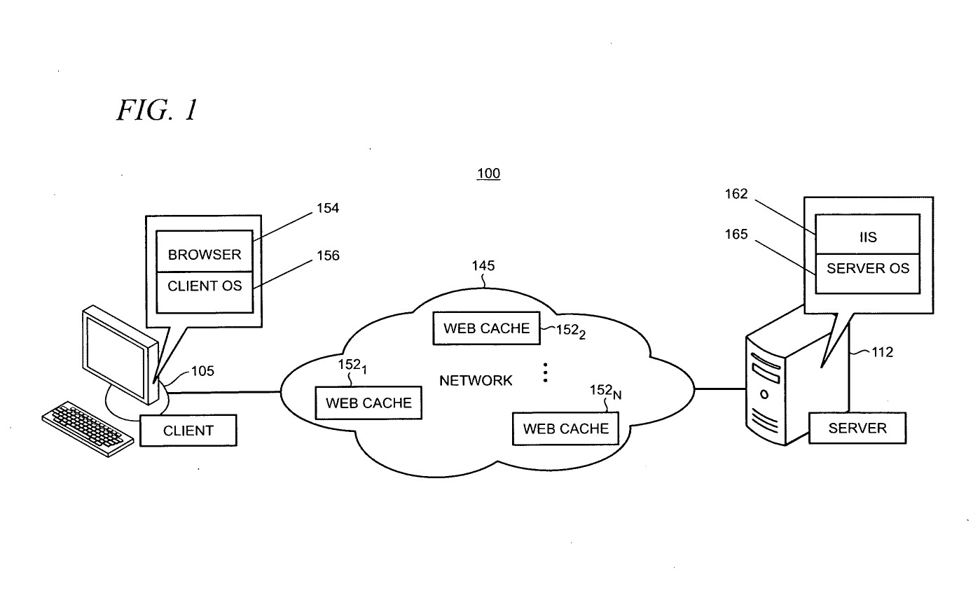

FIG. 1 shows an illustrative internet-based service environment 100 in which a client 105 and a web server 112 communicate over a network 145 that includes a number of web caches 152-1, 2 . . . N. Client 105, which is typically configured as a desktop or laptop PC, hosts a web browser 154 that works in conjunction with an operating system 156. Common examples of these components respectively include Microsoft Internet Explorer® and the Microsoft Windows® operating system. However, other usable browsers include, for example, Mozilla Firefox®, Apple Safari™, Opera, and other illustrative usable operating systems include Apple Mac OS and Linux.

In this illustrative example, the web server 112 is arranged with Microsoft Internet Information Services 162 (“IIS”) which operates with a server operating system 165 such as Windows Server. IIS 162 and client browser 154 are arranged to communicate over the network 145 which commonly is configured to use portions of public networks such as the Internet. Such communication is typically facilitated using HTTP (Hypertext Transfer Protocol) to enable web pages to be requested from the client browser 154 and the appropriate files to be located and returned in response by IIS 162. Various web services development technologies may also be used with IIS 162 to create dynamic web content, for example, Active Server Pages (“ASP”), ASPX files under the ASP.NET framework, Internet server application programming interface (“ISAPI”) extensions and filters, PHP (Personal Home Page) pages, CGI (Common Gateway Interface) applications, and the like. Accordingly, web pages are commonly built using a variety of sources including static files, scripts, compiled DLLs (dynamic linked libraries), and compiled EXEs (executable code). Such sources build the HTML (HyperText Markup Language) code used in the pages that the IIS 162 sends in response to the requests from the client browser 154.

It is emphasized that the utilization of IIS 162 is merely illustrative as other web servers may also be utilized in various applications. However, in most typical settings where servers play numerous roles including file serving, searching, and running applications, a fast server is generally preferred to ensure a user experience at the client browser 154 that meets expectations.

Web caches 152 are located at various locations in the network 145 between the server 112 and client 105. Web caches 152 are generally configured to watch requests from browsers that are coupled to the network and save copies of the responses, which may include HTML, images, and files, from web servers. When another request comes into the network 145 with the same URL (Uniform Resource Locator), a web cache can use the saved response rather than relaying the request back to the origin server to get the same content again. Most browsers are also able to implement local caching that operates in a similar manner.

Web caches 152 generally reduce latency in the network 145 because the request from a browser may often be satisfied by a web cache that is closer to the client than the origin server so it takes less time to get the requested content. Web caches 152 also reduce total traffic traveling over network 145 because content is reused rather than being generated anew for every response. Both results typically help make the Web seem more responsive to requests and may provide a substantial contribution to a positive user experience. In addition, utilization of web caches 152 can help the service provider's Web site load faster and reduce load on both server resources and Internet link. Web caches 152 may include both proxy caches and gateway caches.

While web caches 152 are generally distributed over the network 145 and operated by different entities, caching can be controlled to some extent by the server using controls that conform to rules under the HTTP protocols defined by the World Wide Web Consortium (“W3C”). The cache controls are commonly included in the HTTP response headers. For example, the Expires HTTP header is the basic means of controlling the web caches 152 by indicating how long the content is “fresh” (i.e., fresh content will be served to the client directly from the cache without checking with the origin server). Web caching may be implemented using a variety of solutions including, for example, the Microsoft ISA Server (Internet Security and Acceleration) edge gateway product, and private “Content Delivery Networks” (“CDNs”) which employ cooperative nodes to transparently move content such as those using product offerings from Savvis, Inc. and Akamai Technologies.

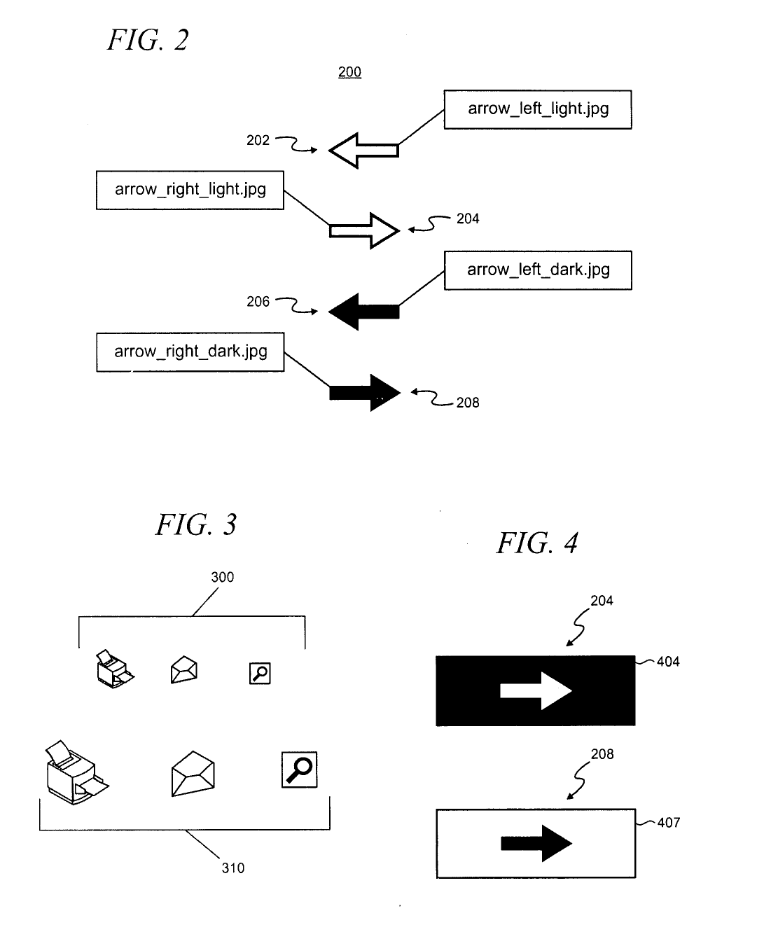

FIG. 2 shows an illustrative set 200 of image assets that are describable by variable parameters that are used to facilitate implementation of the present arrangement for run-once static content generation based on a descriptive file path. Image asset set 200 is representative of a variety of different elements that may be used to create a web page in response to a request from a client. The image assets 200 here are JPEG (Joint Photographic Experts Group) files with a .jpg extension which is a format that is commonly used for images. Other common image file types include GIF (Graphic Interchange Format).

The image assets in this example are considered to be “static” content because they are stored as existing files in a file system (i.e., on disk) that is available to the server 112 (FIG. 1). Static content returned to the browser will always be the same for each request. “Dynamic” content, by contrast, is typically generated on the fly through the execution of script or code provided, for example, from an application or an application programming interface called by the server, and will thus generally be customized to each request. Web pages often use a combination of static and dynamic content.

As shown, the set of image assets 200 include four variations of a base asset named Arrow: a left-direction, light-colored arrow 202, a right-direction, light-colored arrow 204, a left-direction, dark-colored arrow 206, and a right-direction, dark-colored arrow 208. These have respective file names: arrow_left_light.jpg; arrow_right_light.jpg; arrow_left_dark.jpg; and arrow_right_dark.jpg.

In this example, Arrow is defined as a base asset because different variations of the arrow will typically be used for different themes. As evident in FIG. 2, Arrow varies according to direction, as well as lightness or darkness (a characteristic referred to as “Luminance” here). Direction and Luminance are examples of named variable parameters which are used to describe a particular variation of the arrow through the values specified for each of the variable parameters.

In this example, the variable parameter Direction has values of Left or Right. The variable parameter Luminance has values of Light or Dark. It is possible that these same variable parameters Direction and Luminance may be applied to other base assets used in a page and the range of values may also vary. For example, text may include variations of light and dark, or include a range that includes multiple intermediate shades between light and dark. The particular declaration of variable parameters and associated values can typically be expected to vary to meet the needs of a particular scenario.

A web site developer or page author will generally deploy a variety of static base assets in a given page. Such base assets can comprise a variety of conventional static objects that are used to compose web pages such as containers, text, headers, footer, sidebars, images, controls, graphics, etc. By defining one or more variable parameters with each base asset, a variety of different themes can be readily implemented simply by specifying different values for each of the variable parameters. The application of different themes can provide a different look and feel for the web site even if the underlying page composition, navigation, layout, or other content in the site do not change.

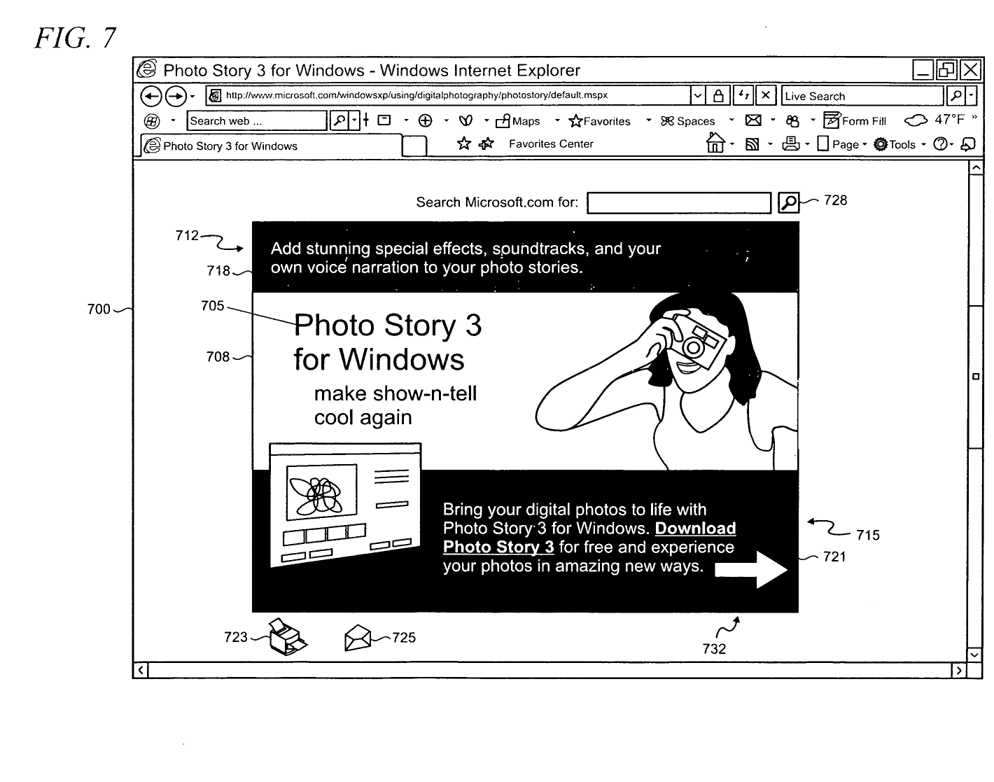

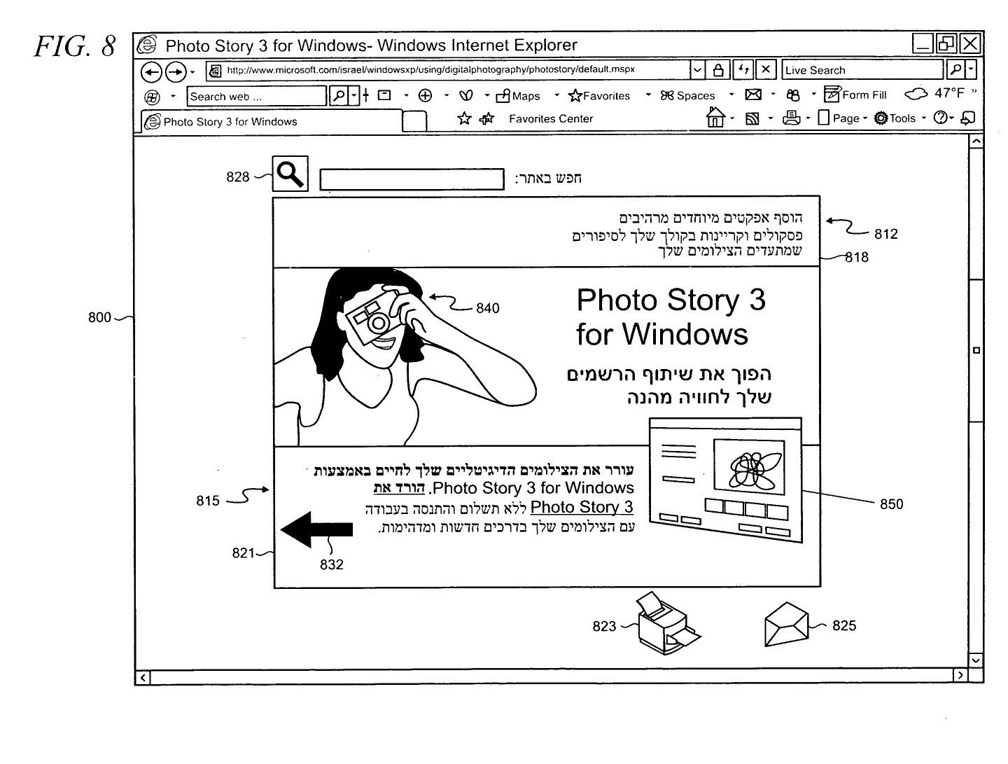

In the present arrangement, the values used to specify which theme is applied may be set via server-side processing, for example, through utilization of an application, or other web development technology, that defines or implements a theme when building the page content. System parameters and/or user input can also be used as factors which are used when specifying values for the variable parameters. Examples of theme application to different pages are shown in FIGS. 7 and 8 and described in the accompanying text.

Another example of a variable parameter that may be defined and associated with particular static base assets is Size. FIG. 3 shows a set 300 which includes several illustrative common icons which are typically used as control elements on a web page, namely print, email, and search. In some settings, for example those where accessibility is a design consideration, the values for the Size variable parameter can include Small and Large. The large icons are indicated by reference numeral 310 in FIG. 3.

FIG. 4 shows a simple illustrative example of how values for variable parameters may be changed to implement themes having distinct appearances. In this example, a container 404 has the value Dark specified for its Luminance variable parameter. Arrow 204 has the value Light specified for its Luminance variable parameter, and value Right specified for its Direction variable parameter. By contrast, container 407 has the value Light specified for its Luminance variable parameter. Arrow 208 has the value Dark specified for its Luminance variable parameter, and value Right specified for its Direction variable parameter. While both container and arrow examples provide the required contrast to facilitate satisfactory interaction with a user, the themes implemented by the specified values for the variable parameter are distinct. Of course, variations in color and other design elements can provide a significantly larger number of variations in thematic presentation than what can be shown here in black and white.

In accordance with the principles of the present arrangement, static base assets that have variations describable using variable parameters are declared by a file name that uses a unique syntax that includes the variable parameter name. The syntax is
_˜[variable name]˜
   can typically be located anywhere in the file name. Thus, the HTML code for a page that employs an Arrow base asset (as described above in the text accompanying FIG. 2) will typically include an <img> tag having a src attribute that declares the file name for the base asset in a URL:

<img
src=“http://shared.live.com/images/arrow_~direction~_~luminance~.jpg”
alt=“ ” width=“50” height=“50”> (1)

The URL contained in the <img> tag (1) above does not include a file name that matches any of the actual file names for the four Arrow variations shown in FIG. 2. However, as described in detail below, the URL is parsed using a process that breaks out the variable parameters and allows the appropriate variation to be located and included in the response. Accordingly, the use of variable parameters can simplify page development by designers since a base asset will not need to be redeployed in order to accommodate different and changing themes that may be used or introduced over time. For example, more Arrow variations might be developed to provide more directions (e.g., up, down, diagonal, etc.) or shades (medium-light, medium, medium-dark, etc.) in subsequently-released theme versions. Advantageously, the original descriptive file path with the Direction and the Luminance variable parameters in the URL will still enable the desired variation to be located and served in the response through specification of the appropriate values.

Most web pages will typically include a multiplicity of <img> tags using the file naming syntax shown above for the various static base assets that are utilized in a given page. It is emphasized that the present arrangement is applicable to any type of static asset and not merely images. However, while other static asset types would use different HTML element tags, the file naming syntax shown above would still apply.

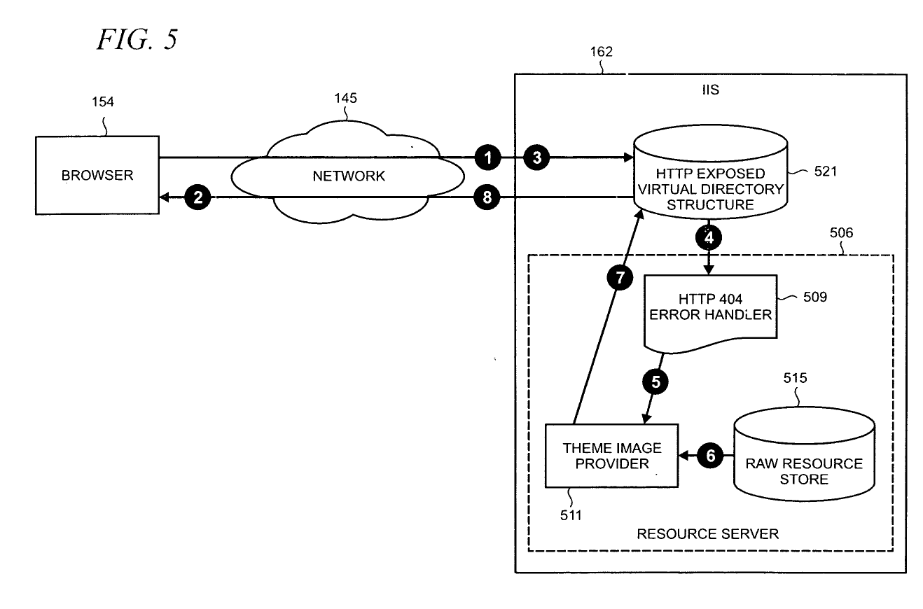

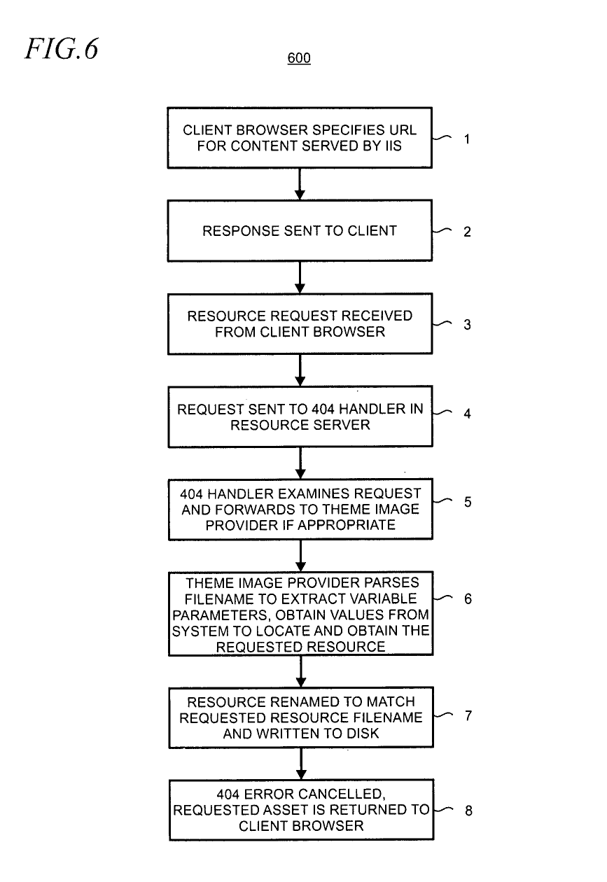

FIGS. 5 and 6 are next presented to show an illustrative methodology that is used by IIS 162 to generate static web content using the file naming syntax which includes the descriptive file path. FIG. 5 shows an illustrative resource server 506 that is arranged as a functional component that is operative in the IIS architecture. Resource server 506 includes an HTTP 404 error handler 509, a theme image provider 511, and a raw resource store 515.

FIG. 6 shows a flowchart 600 that describes the methodology performed by the elements shown in FIG. 5. Each step in the method is indicated on FIG. 5 with a number that maps to the flowchart in FIG. 6 and which is described below. A user at client browser 154 begins by typing or following a link with a URL for web content that is hosted by IIS 162 (Step 1). In this example, the content pages were built using a newly released theme and have not previously been accessed (and thus are not cached). IIS 162 responds with an HTML page (2) that includes multiple elements which declare file names that use descriptive URL paths. In this illustrative example, the elements are assumed to be images which are marked with <img> tags.

As the client browser 154 parses the HTML on the page, it will make requests using the descriptive file path to IIS 162 to obtain the image files that are used in the page (3). When IIS 162 receives a request, it will use the specified URL to attempt to locate the requested file on disk, which in this example, is exposed as a virtual directory 521 (FIG. 5). Because the URL in the request does not contain an actual file name (as noted above), IIS 162 will be unable to locate the file. It would normally then initiate an HTTP 404 error by turning over the request to a 404 error handler in order to send an HTML page containing an error message back to the client browser 154.

However, in the present arrangement, the resource server 506 is registered on the IIS's metabase (not shown) as the 404 error handler. The metabase is a repository for most IIS configuration values and is implemented using a plaintext XML (eXtensible Markup Language) file. Accordingly, IIS 162 hands the request to the 404 error handler 509(4). The 404 error handler 509 is arranged, in this example, as a dynamic ASPX page, which operates to build the requested file rather than sending a static HTML page with the 404 error message back to the client browser 154.

The 404 error handler 509 will parse the URL through use of ASP.NET library classes (that enable server-side scripting, among other functionalities) which are placed on the IIS execution stack to create an ASP.NET runtime along with the resource server assembly. The resource server 506 takes the URL path apart in order to identify the requested image and verify that it is part of a base asset. For example, if the URL contains the file name arrow_˜direction˜_˜luminance˜.jpg as in the above example, then the resource handler will confirm that the requested image is part of the base asset Arrow. If the request is so appropriate, then the request is forwarded to the theme image provider 511 for further processing (5).

The theme image provider 511 parses the file name in the request to identify the variable parameters being used. In this example, these include Direction and Luminance. Theme image provider 511 obtains values for these variable parameters that are appropriate to the theme that is being applied to the page. As noted above, the values that define the theme are typically generated using some server-side process, for example, as provided by an application that builds themed web content responsively, for example, to user input and/or system parameters.

The theme image provider 511 then substitutes the obtained values for the variable parameter names in the file name to identify the actual file which it will retrieve (e.g., copy) from the raw resource store 515(6). For example, if the theme requires an arrow with a Right value for Direction and a Light value for Luminance, then the theme image provider will retrieve the image file named arrow_right_light.jpg (as shown in FIG. 2 by reference numeral 204).

The retrieved asset is then renamed to match the descriptive file name specified by the URL contained in the client browser request described in step 3 above. In this example, arrow_right_light.jpg is renamed arrow_˜direction˜_˜luminance˜.jpg. The renamed asset is then written to the virtual directory 521(7).

The 404 error is then canceled and the client browser request is pointed back to the original URL which now holds the asset that is appropriate to the theme and is responsive to the request. IIS 162 can then generate the response back to the client browser 154 which includes the asset file (8).

Any subsequent requests for the asset using the same URL noted in the <img> tag(1) above will be handled by IIS 162 directly without invoking the method shown in FIG. 6. Therefore, ASP.NET and the resource server assembly will not need to be put on the IIS execution stack.

In most implementations IIS 162 will implement cache controls in the HTTP headers of any subsequent responses to enable caching by the web caches 152 (FIG. 1) in network 145, and by any local cache utilized by the client browser 154. For example, HTTP includes a class of headers, Cache-Control, including “Public” which marks authenticated responses as cacheable because otherwise, if HTTP authentication is required, responses are automatically uncacheable. The “Expires” HTTP header may also be set with an arbitrary value that keeps the response fresh for as long as desired, or even indefinitely. Thus, for example, IIS 162 may include HTTP headers which include:
Cache-Control: public
Expires: Fri, 22 Jan. 2010 15:00 GMT

As each subsequent request uses the same descriptive file name to declare a required asset, the path acts as the key to the newly generated asset that is responsive to the theme. The generation methodology shown in FIGS. 5 and 6 and described in the accompanying text only needs to be run once, after which the key provided by the URL maps to the correct asset, which can be cached in the web caches 152 (FIG. 1) between the server and client to thus improve server performance and enrich the quality of the user experience.

FIGS. 7 and 8 are screenshots of several illustrative web pages which may be displayed by the client browser 154 using the principles of the present arrangement for run-one static content generation based on a descriptive file path. FIG. 7 shows a screenshot of a page 700 rendered by the client browser 154 (which in this example is Microsoft Internet Explorer) that enables users to discover features of a photography product. Various content elements including containers, text, graphics, icons, and controls are included, several of which are implemented using static base assets as described below.

A theme is utilized for the page 700 which is defined by values for the variable parameters. The applied theme in this example results in the headline text 705 being given a Dark value for the variable parameter Luminance in a container 708 that has a Light value for Luminance. This theme results in the headline text 705 appearing dark on a light colored background. By contrast, the sub-headline texts 712 and 715 in respective containers 718 and 721 have opposite values for Luminance so that the text appears light on a dark colored background.

An arrow 732 is also shown in which the values for variable parameters Direction and Luminance are, respectively, Right and Light. In this example, the theme specifies the Luminance value for the arrow 732 as Light since it is positioned in container 721 which has a Luminance value of Dark.

The value of the variable parameter Direction is not theme-driven as is the case with Luminance. Instead, the Direction value is based on the locale of the user at the client browser 154. In particular, the Direction value for arrow 732 is dependent on the language used on the page. The text in this example is English which reads from left to right. Arrow 732 which is used to graphically indicate “next page” or “continue” must therefore be right facing in order to convey its intended message to the user. Accordingly, the server-side process, for example as implemented via script executing from a dynamic ASPX page, recognizes the locale (and hence the left-to-right text being used) in order to select the value for Direction as Right. This compares with the page shown in FIG. 8 where the language there—Hebrew—is read from right to left.

In some cases, the language displayed by the page is user-selectable from a menu (not shown). In other situations, different URLs (as described in step 1 shown in FIG. 6) will point to different pages where each is designed for a particular language. In both cases, however, it is possible for the page designer to specify a single static base asset for the arrow where the particular variation for direction will be selected based on contextual information provided by the language that is utilized on the page. While this present example uses a relatively simple case where only two variations in direction for this base asset are utilized, it will be appreciated that the savings in page development time can be quite substantial as the number of variations for a given base asset increase.

The page 700 in FIG. 7 further includes images of icons similar to those shown in FIG. 3, including printing, email and search icons, respectively indicated by reference numerals 723, 725, and 728. In this example, the icons are specified as having values of Small for the variable parameter Size. By contrast, the page shown in FIG. 8 utilizes icons having values of Large for the variable parameter Size. In typical scenarios, the values will be set at the system, or application-level in response to a user preference for large or small icons.

As noted above in step 6 shown in FIG. 6, in response to a first request for an asset, the selected values for the variable parameters are obtained by the theme image provider 511 in order to locate and retrieve the correct asset from the raw resource store 515 (FIG. 5). The assets are then returned to the client browser 154 in order to render the page as shown in FIG. 7. And, subsequent requests for the same asset will typically be served from a cache (i.e., a web cache or browser cache).

FIG. 8 shows a screenshot of a page 800 that is rendered by the client browser 154 (FIG. 1). Page 800 has similar subject matter to the page 700 shown in FIG. 7, but is themed using different luminance values for various objects to give it a different look and feel. In addition, page 800 is tailored to users who read Hebrew and could be intended, for example, to serve users who are located in Israel.

In particular, the Luminance values for the sub-headline text 812 and 815 in respective containers 818 and 821 are reversed from those used in FIG. 7. Thus, the color scheme is dark text on a light background. Similarly, the Luminance value for arrow 832 is specified as Dark so that it has appropriate contrast when shown on the light colored background of container 821.

As Hebrew text is read from right to left, many of the elements in page 800 are mirrored across a vertical midline in the page 800. For example, the image of photographer 840 and the application user interface image 850 are mirrored compared to their counterparts shown on page 700 in FIG. 7. And, as noted above in the description accompanying FIG. 7, the value for the variable parameter Direction associated with the arrow 832 is dependent on page context established by the language utilized. Accordingly, to show “next page” or “continue,” a value of Left for the Direction variable parameter will be specified.

In the example shown in FIG. 8, large icons 823, 825 and 828 are utilized by specification of a value of Large for the variable parameter Size. Large icons may be preferred by some users to facilitate accessibility, for example. As noted above, the large icons are implemented using a different specified value for the variable parameter Size as compared with their counterparts shown in FIG. 7.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for creating static content for a web page, the method comprising the steps of:
receiving a request for a base asset, the request including a descriptive file path that is arranged for declaring one or more variable parameters, the one or more variable parameters describing a set of variations that are associated with the base asset;
parsing the one or more variable parameters from the descriptive file path;
obtaining values for each of the one or more variable parameters; and
mapping the values to a file comprising a variation from the set.

2. The method of claim 1 including a further step of retrieving the file from a resource store.

3. The method of claim 2 including a further step of renaming the retrieved file to match the descriptive file path.

4. The method of claim 3 including a further step of including the renamed file in a response to a client browser.

5. The method of claim 1 in which the values are obtained from a server-side process.

6. The method of claim 1 in which the values comprise system parameters.

7. The method of claim 4 in which the values are obtained responsively to user input into the client browser.

8. The method of claim 1 in which the variations of the base asset comprise variations having one or more characteristics which differ from the base asset.

9. The method of claim 8 in which the characteristics are visual characteristics selected from ones of color, size, font, image, background, foreground, transparency, text, language, or icons.

10. The method of claim 1 including a further step of registering a page as an HTTP 404 error handler, the page containing script for implementing a resource server which performs the steps of parsing, obtaining, and mapping.

11. A method for authoring a web page, the method comprising the steps of:
specifying a base asset as a resource for the page, the base asset having a plurality of associated variations and each variation being described with at least one variable parameter; and
declaring a descriptive file path for the base asset, the descriptive file path i) containing the at least one variable parameter and, ii) being arranged to invoke server-side processing for serving a selected variation of the base asset responsively to a client request for the resource.

12. The method of claim 11 in which the server-side processing comprises application logic, the application logic being implementable by one of ASP, ASP.NET, ISAPI, CGI, PHP, or script.

13. The method of claim 11 in which the base asset or variations comprise static content.

14. The method of claim 11 in which the server-side processing further specifies a value for the at least one variable parameter to implement a theme for the page.

15. A method for improving responsiveness of web service provided by a web server to a client, the method comprising the steps of:
receiving a request from a web server process that includes a declaration of an asset, the declaration using a syntax that places at least one variable parameter in the asset's file name contained in a URL;
mapping a value for the at least one variable parameter to a variation of the asset in a resource store that is exposed to the web server; and
generating a response to the request for the client, the response including the variation of the asset.

16. The method of claim 15 including a further step of manipulating a header in the response to implement cache control.

17. The method of claim 16 in which the manipulating includes setting an HTTP Expire header.

18. The method of claim 16 in which the manipulating includes setting an HTTP Cache-Control header.

19. The method of claim 15 in which the response is cached using the URL.

20. The method of claim 15 in which the value is set in accordance with a theme.
